(19) United States
(12) Patent Application Publication
(10) Pub. No.: US 2016/0054495 A1
(43) Pub. Date: Feb. 25, 2016

(54) ORIENTATION FILM FORMING COMPOSITION

(71) Applicant: SUMITOMO CHEMICAL COMPANY, LIMITED, Tokyo (JP)

(72) Inventor: Tadahiro KOBAYASHI, Osaka-shi, Osaka (JP)

(21) Appl. No.: 14/783,688

(22) PCT Filed: Apr. 10, 2014
(86) PCT No.: PCT/JP2014/060883

§ 371 Date: Oct. 9, 2015

(30) Foreign Application Priority Data
Apr. 11, 2013 (JP) 2013-082695

(51) Int. Cl. G02B 5/30; G02F 1/1337

(52) U.S. Cl. CPC G02B 5/3016; G02F 1/133723

(57) ABSTRACT

A composition for forming an orientation film is provided. The composition includes a material for forming an orientation film, N-methyl-2-pyrrolidone, and a hydrocarbon with a boiling point of 100° C. to 200° C.

### TECHNICAL FIELD

The present invention relates to a composition for forming an orientation film.

### BACKGROUND ART

A flat panel display device (FPD) makes use of a member including an optically anisotropic film such as a polarizing plate or a retardation plate. As such an optically anisotropic film, known is an optically anisotropic film produced by coating a composition containing a liquid crystal compound onto a substrate. For example, Patent Document 1 describes an optically anisotropic film formed by coating a composition containing a liquid crystal compound onto a substrate subjected to orienting treatment.

### PRIOR ART DOCUMENT

### Patent Document

Patent Document 1: JP-A-2007-148098

### SUMMARY OF THE INVENTION

### Problems to be Solved by the Invention

Improvement in adhesion between a substrate and an optically anisotropic film has been required.

### Means for Solving the Problems

The present invention includes the following inventions.

[1]A composition for forming an orientation film which includes a material for forming an orientation film, N-methyl-2-pyrrolidone, and a hydrocarbon with a boiling point of 100° C. to 200° C.
[2] The composition for forming an orientation film according to item [1], wherein the hydrocarbon with a boiling point of 100° C. to 200° C. is at least one kind selected from the group consisting of methylcyclohexane, ethylcyclohexane and propylcyclohexane.
[3] The composition for forming an orientation film according to item [1] or [2], wherein the content of N-methyl-2-pyrrolidone is 60% by mass to 99.9% by mass, and the content of hydrocarbon with a boiling point of 100° C. to 200° C. is 0.1% by mass to 40% by mass, related to the total amount of the composition for forming an orientation film.
[4] The composition for forming an orientation film according to any of items [1] to [3], wherein the material for forming an orientation film contains at least one kind selected from polyimide, polyamide and polyamic acid.
[5]A resin substrate with an orientation film having an orientation film formed from the composition for forming an orientation film as defined in any of items [1] to [4], on the surface of the resin substrate.
[6] The resin substrate with an orientation film according to item [5], wherein the resin substrate is made of a polyolefin resin.
[7]A method for producing a resin substrate with an orientation film including coating the composition for forming an orientation film as described in any of items [1] to [4] onto the resin substrate and drying the composition for forming an orientation film.
[8]A laminated body having the resin substrate with an orientation film as described in item [5] or [6] and an optically anisotropic film, in the order of the resin substrate, the orientation film and the optically anisotropic film.
[9] The laminated body according to item [8], wherein 80% or more by area of the orientation film is not peeled off from the substrate, in an adhesion test in accordance with JIS-K5600.
[10] The laminated body according to item [8] or [9], wherein the optically anisotropic film is a retardation film.
[11] The laminated body according to any of items [8] to [10] for an IPS (in-plane switching) liquid crystal display device.
[12] A method for producing a laminated body having a resin substrate, an orientation film and an optically anisotropic film, in this order, including coating the composition as defined in items [1] to [4] onto the resin substrate to produce the resin substrate with an orientation film, coating a composition further containing a polymerizable liquid crystal compound and a photopolymerization initiator onto the surface of the orientation film of the resin substrate with an orientation film, and photoirradiating the composition.
[13]A polarizing plate having the laminated body as described in any of items [8] to [11].
[14]A display device including the laminated body as described in any of items [8] to [11].

### Effect of the Invention

According to the composition for forming an orientation film of the present invention, adhesion between an orientation film and a resin substrate can be improved, and further, adhesion between a resin substrate, an orientation film and an optically anisotropic film can be improved in a laminated body having a resin substrate, an orientation film and an optically anisotropic film.

### BRIEF DESCRIPTION OF THE DRAWINGS

FIGS. 1(a) to 1(e) are each a schematic view illustrating an example of the polarizing plate according to the present invention.

FIGS. 2(a) and 2(b) are each a schematic view illustrating an example of the display device according to the present invention.

### MODE FOR CARRYING OUT THE INVENTION

The composition for forming an orientation film of the present invention includes a material for forming an orientation film, N-methyl-2-pyrrolidone, and a hydrocarbon with a boiling point of 100° C. to 200° C.

Examples of the material for forming an orientation film include an orienting polymer and a photo-orienting polymer, and is preferably an orienting polymer.

The material for forming an orientation film has solvent resistance that does not dissolve in a solvent used when coating a composition containing the liquid crystal compound set forth below and heat resistance in the heat treatment for adjusting removal of an organic solvent and orientation of the liquid crystal compound.

Examples of the orienting polymer include polyamides and gelatins, which each have amide bonds in the molecule, polyimides, which each have imide bonds in the molecule, polyamic acids, which are each a hydrolyzate of a polyimide, polyvinyl alcohols, alkyl-modified polyvinyl alcohols, polyacrylamides, polyoxazoles, polyethyleneimines, polystyrenes, polyvinyl pyrrolidones, polyacrylic acids, and polyacrylates. Among them, the orienting polymer is preferably at least one kind selected from polyamides, polyimides and polyamic acids. The orienting polymer may be one kind, a composition obtained by combining plural kinds of polymers, or a copolymer having plural kinds of polymers. These polymers can be easily obtained by polycondensation such as dehydration and dealcoholization, chain polymerization such as radical polymerization, anion polymerization and cation polymerization, coordination polymerization, ring-opening polymerization or the like, of a monomer.

Examples of the commercially available orienting polymer include products SUNEVER (registered trademark, manufactured by Nissan Chemical Industries, Ltd.), OPTMER (registered trademark, manufactured by JSR Corporation), and the like.

The orientation film composed of an orienting polymer facilitates the liquid crystal orientation of the liquid crystal compound. In accordance with the kind of the orienting polymer, or rubbing conditions, the liquid crystal orientation can be controlled into various orientations such as horizontal orientation, vertical orientation, hybrid orientation, and oblique orientation, and can be utilized for improvement of a viewing angle of various liquid crystal panels, and the like.

The photo-orienting polymer includes a polymer having a photosensitive structure. When the polymer having a photosensitive structure is irradiated with polarized light, the photosensitive structure in the irradiated portion is isomerized or crosslinked such that the photo-orienting polymer is oriented, and orientation regulating force is given to a layer made of the photo-orienting polymer. Examples of the photosensitive structure include an azobenzene structure, a maleimide structure, a chalcone structure, a cinnamic acid structure, a 1,2-vinylene structure, a 1,2-acetylene structure, a spiropyran structure, a spirobenzopyrane structure, a fulgide structure, and the like. The photo-orienting polymer forming an orientation film may be one kind, a combination of a plurality of polymers having different structures, or a copolymer having a plurality of different photosensitive structures. The photo-orienting polymer can be obtained by polycondensation such as dehydration and dealcoholization, chain polymerization such as radical polymerization, anion polymerization and cation polymerization, coordination polymerization, ring-opening polymerization or the like, of a monomer having a photosensitive structure. Examples of the photo-orienting polymer include photo-orienting polymers described in Japanese Patent Nos. 4450261 and 4011652, JP-A-2010-49230, Japanese Patent No. 4404090, JP-A-2007-156439, JP-A-2007-232934, and the like. Among them, as the photo-orienting polymer, a polymer forming crosslinked structure by polarized light irradiation is preferred, from the viewpoint of durability.

N-Methyl-2-pyrrolidone and a hydrocarbon with a boiling point of 100° C. to 200° C. contained in the composition for forming an orientation film are a solvent. N-Methyl-2-pyrrolidone tends to sufficiently dissolve a material for forming an orientation film, and the hydrocarbon with a boiling point of 100° C. to 200° C. tends to improve adhesion between an orientation film formed from the composition for forming an orientation film and a resin substrate.

The boiling point referred herein means a boiling point at 1 atm.

The hydrocarbon herein refers to a compound made of carbon atoms and hydrogen atoms.

Examples of the hydrocarbon with a boiling point of 100° C. to 200° C. include chain aliphatic hydrocarbons such as octane, nonane, decane, 2,4-dimethylhexane, 2,5-dimethylhexane, 2-methylheptane, 3-methylheptane, 2-methyloctane and 3-methyloctane, aromatic hydrocarbons such as ethylbenzene, n-propylbenzene, m-ethyltoluene, p-ethyltoluene, o-xylene, m-xylene, p-xylene and mesitylene, and cyclic aliphatic hydrocarbons such as cycloheptane, cyclooctane, cyclononane, cyclodecane, methylcyclohexane, ethylcyclopentane, ethylcyclohexane and propylcyclohexane. The hydrocarbon with a boiling point of 100° C. to 200° C. is preferably a cyclic aliphatic hydrocarbon, more preferably methylcyclohexane, ethylcyclohexane or propylcyclohexane, and further preferably ethylcyclohexane.

The content of N-methyl-2-pyrrolidone is preferably 60% by mass to 99.9% by mass, more preferably 65% by mass to 99% by mass, and further preferably 70% by mass to 99% by mass, related to the total amount of the composition for forming an orientation film.

The content of hydrocarbon with a boiling point of 100° C. to 200° C. is preferably 0.1% by mass to 40% by mass, more preferably 1% by mass to 30% by mass, and further more preferably 5% by mass to 20% by mass, related to the total amount of the composition for forming an orientation film.

The content ratio of N-methyl-2-pyrrolidone to the hydrocarbon with a boiling point of 100° C. to 200° C. is usually 10:1 to 3:1, and preferably 9:1 to 5:1.

The composition for forming an orientation film may contain a solvent other than N-methyl-2-pyrrolidone and the hydrocarbon with a boiling point of 100° C. to 200° C. Examples of the solvent include water; alcohol solvents such as methanol, ethanol, ethylene glycol, isopropyl alcohol, propylene glycol, methylcellosolve, and butylcellosolve; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; aliphatic hydrocarbon solvents such as pentane, hexane, and heptane; aromatic hydrocarbon solvents such as benzene (except for hydrocarbons with a boiling point of 100° C. to 200° C.); nitrile solvents such as acetonitrile; ether solvents such as propylene glycol monomethyl ether, tetrahydrofuran, and dimethoxyethane; halogenated hydrocarbon solvents such as chloroform; and the like. Such organic solvents may be used alone or in combination.

An alcohol solvent is preferable as the solvent.

The content of the solvent is preferably 10 parts by mass to 100000 parts by mass, more preferably 1000 parts by mass to 50000 parts by mass, and further preferably 2000 parts by mass to 20000 parts by mass, related to 100 parts by mass of the material for forming an orientation film.

The content excluding N-methyl-2-pyrrolidone, the hydrocarbon with a boiling point of 100° C. to 200° C. and the solvent from the composition for forming an orientation film is preferably 0.2% by mass to 10% by mass, and more preferably 0.5% by mass to 5% by mass, related to the total mass of the composition for forming an orientation film.

In addition, the present invention relates to a resin substrate with an orientation film obtained by coating a composition for forming an orientation film onto a resin substrate. The resin substrate with an orientation film refers to one in which an orientation film is formed on the surface of the resin substrate. The resin substrate with an orientation film formed from the composition for forming an orientation film is less likely to cause peeling of the orientation film due to friction in transportation or the like.

The resin substrate is usually a translucent resin substrate. The translucent resin substrate means a resin substrate having such a translucency that the resin substrate can transmit light, in particular, visible rays. Translucency denotes a property that the transmittance of any object or member to light rays having wavelengths from 380 to 780 nm is 801 or more. The resin substrate may be usually a substrate in the form of a film.

Examples of the resin that constitutes the translucent resin substrate include polyolefins such as polyethylene, polypropylene, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylenesulfides; and polyphenylene oxides. Preferred are polyolefins such as polyethylene, polypropylene and norbornene-based polymers, polyethylene terephthalate, and polymethacrylates. More preferred are such polyolefins.

The resin substrate may be subjected to surface treatment before coating the composition for forming an orientation film. Examples of the method for the surface treatment include a method of treating a surface of the resin substrate with corona or plasma in a vacuum or an atmospheric pressure; a method of treating a surface of the resin substrate with a laser; a method of treating a surface of the resin substrate with ozone; a method of subjecting a surface of the resin substrate to saponifying treatment or a method of subjecting a surface of the resin substrate to flame treatment; a method of coating a coupling agent onto a surface of the resin substrate to subject to primer treatment; and a graft-polymerization method of causing a reactive monomer or a polymer having reactivity to adhere onto a surface of the resin substrate, and then irradiating the monomer or polymer with radial rays, plasma or ultraviolet rays to cause a reaction of the monomer or polymer. Among them, preferred is the method of treating a surface of the resin substrate with corona or plasma in a vacuum or an atmospheric pressure.

The method of treating a surface of the resin substrate with corona or plasma is, for example,

a method of setting the resin substrate between opposed electrodes under a pressure close to the atmospheric pressure, and then generating corona or plasma to treat the surface of the resin substrate therewith,

a method of causing a gas to flow into the gap between opposed electrodes, making the gas into plasma between the electrodes, and blowing the plasma-state gas onto the resin substrate;

or a method of generating glow discharge plasma under a low pressure to treat the surface of the resin substrate therewith.

Among them, preferred are the method of setting the resin substrate between opposed electrodes under a pressure close to the atmospheric pressure, and then generating corona or plasma to treat the surface of the resin substrate therewith, and the method of causing a gas to flow into the gap between opposed electrodes, making the gas into plasma between the electrodes, and blowing the plasma-state gas onto the resin substrate. Usually, these surface treatments with corona or plasma can be conducted in a commercially available surface treatment apparatus.

Examples of the method for producing a resin substrate with an orientation film include a method of coating a composition for forming an orientation film onto the resin substrate and drying it; a method of coating a composition for forming an orientation film onto the resin substrate, drying it, and rubbing the surface thereof; a method of coating a composition for forming an orientation film onto the resin substrate, drying it, and irradiating with polarized light; and the like.

Among them, from the viewpoint of uniformity of liquid crystal orientation of the liquid crystal compound formed on the orientation film, production time and production cost, preferred are the method of coating a composition for forming an orientation film containing an orienting polymer and drying the composition, and the method of coating, drying the composition, and rubbing the surface thereof.

Examples of the method for coating the composition for forming an orientation film onto the resin substrate include extrusion coating, direct gravure coating, reverse gravure coating, CAP coating, die coating methods, and the like. Also, examples include a method of coating using a coater such as a dip coater, a bar coater or a spin coater.

The resin substrate with an orientation film can be produced, for example, by coating a composition for forming an orientation film onto the resin substrate, drying it, thereby removing low boiling point components such as solvent.

Examples of the drying method include natural drying, ventilation drying, heat drying, and reduced-pressure drying; and any combination of these methods. The drying temperature is preferably from 10° C. to 250° C., more preferably from 25° C. to 200° C. The drying period, which depends on the kind of the solvent, is preferably from 5 seconds to 60 minutes, more preferably from 10 seconds to 30 minutes.

In the material for forming orientation films, depending on its kind, some exhibit properties of allowing liquid crystal orientation of a liquid crystal compound only by coating and drying (hereinafter, may be referred to as orientation regulating force), and others exhibit orientation regulating force by further performing rubbing or polarized ultraviolet ray irradiation.

Examples of the rubbing method include a method of bringing a rubbing-cloth-wound rubbing roll that is being rotated into contact with a layer formed by coating a composition for forming an orientation film onto the resin substrate and drying it (hereinafter, sometimes referred to as dry coating).

Dry coating formed from a photo-orienting polymer is usually irradiated with polarized light. As the photo-orienting polymer, a polymer forming crosslinked structure by photoirradiation is preferred, from the viewpoint of durability of the orientation film.

The method for irradiating polarized light includes methods performed using a device described in JP-A-2006-323060. In addition, a patterned orientation film can be also formed by repeatedly irradiating polarized light such as linear polarized ultraviolet rays via photomask corresponding to a plurality of desired regions, for each region. As the photomask, one provided with a shielding pattern on a film such as quartz glass, soda lime glass or polyester is usually used. In the portion covered with the shielding pattern, polarized light to be irradiated is shielded, and in the portion not being covered, polarized light to be irradiated is transmitted. Quartz glass is preferred from the viewpoint of small effect of thermal expansion. The polarized light to be irradiated is preferably ultraviolet ray, from the viewpoint of reactivity of the photo-orienting polymer.

The thickness of the orientation film formed on the resin substrate with an orientation film is usually from 10 nm to 10000 nm, and preferably from 10 nm to 1000 nm. It is preferred when the thickness of the orientation film is in the above range, since the liquid crystal compound can be oriented in the desired direction or angle on the orientation film.

The resin substrate with an orientation film of the present invention has high adhesion between an orientation film and a resin substrate, thus peeling of the orientation film from the resin substrate can be suppressed during processing. Adhesion can be evaluated by an adhesion test in accordance with JIS-K5600. For example, it is advisable to perform the adhesion test, using a commercially available device, such as a Cross-Cut Guide I Series device (CCI-1; a device for 25 squares having intervals of 1 mm) manufactured by COTEC CORPORATION. For example, when the adhesion test of the resin substrate with an orientation film is performed using a Cross-Cut Guide I Series device (CCI-1; a device for 25 squares having intervals of 1 mm), the number of squares in each of which the orientation film is held without being peeled from the resin substrate, out of the 25 squares, is usually 9 or more. Thus, 36% or more by area of the orientation film is held on the resin substrate without being peeled from the resin substrate.

The resin substrate with an orientation film is useful as a substrate for forming an optically anisotropic film such as a retardation film or a polarization film, and furthermore, also useful as a member for a polarizing plate or circularly polarizing plate that includes such an optically anisotropic film. Among them, the resin substrate with an orientation film is useful as a substrate of a retardation film.

A liquid crystal compound is oriented on the surface of the resin substrate with an orientation film, whereby a retardation film can be obtained. Examples of the orientation include vertical orientation, horizontal orientation, hybrid orientation, oblique orientation, and the like. The vertical orientation herein denotes that the liquid crystal compound has a long axis thereof in a perpendicular direction relative to the plane of the resin substrate, and the horizontal orientation herein denotes that the liquid crystal compound has a long axis thereof in a parallel direction relative to the plane of the resin substrate.

A polymerizable liquid crystal compound is preferable as the liquid crystal compound. The polymerizable liquid crystal compound refers to a liquid crystal compound having a polymerizable group. Usually, the polymerizable liquid crystal compound forms an optically anisotropic film by liquid-crystal-orienting this compound on the surface of an orientation film and then polymerizing the compound.

The liquid crystal orientation of the liquid crystal compound is controlled by respective properties of the orientation film and the liquid crystal compound. For attaining vertical orientation, it is preferred to select a liquid crystal compound that is vertically oriented with ease, and an orientation film that easily causes this liquid crystal compound to be vertically oriented.

When the orientation film is made of, for example, a material expressing, as orientation regulating force, horizontal orientation, the liquid crystal compound can attain horizontal orientation or hybrid orientation. When the orientation film is made of a material expressing vertical orientation, the liquid crystal compound can attain vertical orientation or oblique orientation.

When the orientation film is composed of an orienting polymer, the orientation regulating force is optionally adjustable in accordance with the surface state or rubbing conditions. When the orientation film is composed of a photo-orienting polymer, the orientation regulating force is optionally adjustable in accordance with polarized-light-irradiating conditions and the like. The liquid crystal orientation is also controllable by selecting the surface tension, the liquid crystal property or the like of the liquid crystal compound.

In forming an optically anisotropic film in which the liquid crystal compound is liquid-crystal-oriented, a composition containing a liquid crystal compound (hereinafter, may be referred to as composition for forming an optically anisotropic layer) is usually used. The composition may include two or more kinds of the liquid crystal compounds.

Examples of the liquid crystal compound include a compound containing a group represented by a formula (X) (hereinafter, may be referred to as the “compound (X)”).

P¹¹-B¹¹-E¹¹-B¹²-A¹¹-B¹³- (X)

wherein P¹¹ represents a polymerizable group or a hydrogen atom;

A¹¹ represents a bivalent alicyclic hydrocarbon group or bivalent aromatic hydrocarbon group provided that any hydrogen atom contained in the bivalent alicyclic hydrocarbon group or bivalent aromatic hydrocarbon group is optionally substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms is optionally substituted with a fluorine atom;

B¹¹ represents —O—, —S—, —CO—O—, —O—CO—, —O—CO—O—, —CO—NR¹⁶—, —NR¹⁶—CO—, —CO—, —CS— or a single bond wherein R¹⁶s each represent a hydrogen atom or an alkyl group having 1 to 6 carbon atoms;

B¹² and B¹³ each independently represent —C═C—, —CH═CH—, —CH₂—CH₂, —O—, —S—, —C(═O)—, —C(═O)—O—, —O—C(═O)—, —O—C(═O)—O—, —CH═N—, —N═CH—, —N═N—, —C(═O)—NR¹⁶, —NR¹⁶—C(═O)—, —OCH₂—, —OCF₂—, —CH₂O—, —CF₂O—, —CH═CH—C(═O)—O—, —O—C(═O)—CH═CH—, or a single bond; and

E¹¹ represents an alkanediyl group having 1 to 12 carbon atoms provided that any hydrogen atom contained in the alkanediyl group is optionally substituted with an alkoxy group having 1 to 5 carbon atoms provided that any hydrogen atom contained in the alkoxy group is optionally substituted with a halogen atom, and; also, any —CH₂— that constitutes the alkanediyl group is optionally replaced with —O— or —CO—.

The number of the carbon atoms of the aromatic hydrocarbon group and alicyclic hydrocarbon group as A¹¹ is preferably in the range of 3 to 18, more preferably in the range of 5 to 12, in particular preferably 5 or 6. A¹¹ is preferably a cyclohexane-1,4-diyl group, or 1,4-phenylene group.

E¹¹ is preferably a linear alkanediyl group having 1 to 12 carbon atoms. Any —CH₂— that constitutes the alkanediyl group is optionally replaced with —O—.

Specific examples thereof include linear alkanediyl groups having 1 to 12 carbon atoms, such as methylene, ethylene, propane-1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; —CH₂—CH₂—O—CH₂—CH₂—, —CH₂—CH₂—O—CH₂—CH₂—CH₂—O—CH₂—CH₂—, and —CH₂—CH₂—O—CH₂—CH₂—O—CH₂—CH₂—O—CH₂—CH₂—; and the like.

B¹¹ is preferably —O—, —S—, —CO—O—, or —O—CO—, more preferably —CO—O—.

B¹² and B¹³ are each independently preferably —O—, —S—, —C(═O)—, —C(═O)—O—, —O—C(═O)—, or —O—C(═O)—O—, and more preferably —O—, or —O—C(═O)—O—.

P¹² is preferably a polymerizable group. The polymerizable group is preferably a radical polymerizable group or cation polymerizable group since the group is high in polymerization reactivity, in particular, photopolymerization reactivity. The polymerizable group is preferably a group represented by any one of the following formulae (P-11) to (P-15) since the liquid crystal compound having the group is easy to handle, and is also easily produced:

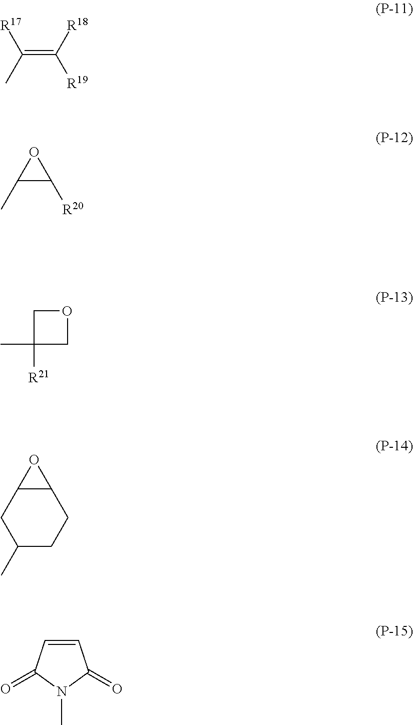

wherein in the formulae (P-11) to (P-13),

R¹⁷ to R²¹ each independently represent an alkyl group having 1 to 6 carbon atoms, or a hydrogen atom.

Specific examples of the group represented by any one of the formulae (P-11) to (P-15) include respective groups represented by the following formulae (P-16) to (P-20):

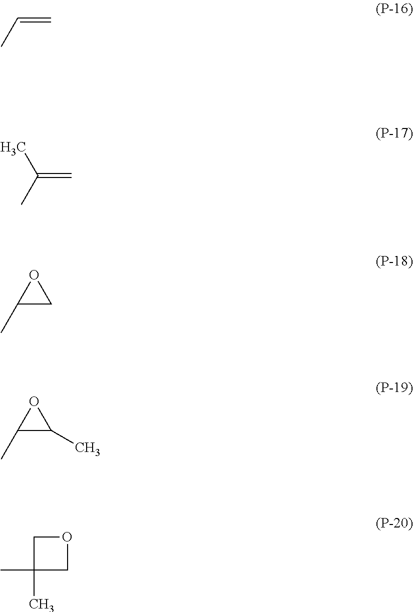

P¹² is preferably a group represented by any one of the formulae (P-14) to (P-20), more preferably a vinyl, p-stilbene group, epoxy or oxetanyl group.

Further preferably, the group represented by P¹¹-B¹¹- is an acryloyloxy or methacryloyloxy group.

Examples of the compound (X) include respective compounds represented by the following formulae (I), (II), (III), (IV), (V) and (VI):

P¹¹-B¹¹-E¹¹-B¹²-A¹¹-B¹³-A¹²-B¹⁴-A¹³B¹⁵-A¹⁴-B¹⁶-E¹²-B¹⁷-P¹² (I)

P¹¹-B¹¹-E¹¹-B¹²-A¹¹-B¹³-A¹²-B¹⁴-A¹³-B¹⁵-A¹⁴-F¹¹ (II)

P¹¹-B¹¹-E¹¹-B¹²-A¹¹-B¹³-A¹²-B¹⁴-A¹³-B¹⁵-E¹²-B¹⁷-P¹² (III)

P¹¹-B¹¹-E¹¹-B¹²-A¹¹-B¹³-A¹²-B¹⁴-A¹³-F¹¹ (IV)

P¹¹-B¹¹-E¹¹-B¹²-A¹¹-B¹³-A¹²-B¹⁴-E¹²-B¹⁷-P¹² (V)

P¹¹-B¹¹-E¹¹-B¹²-A¹¹-B¹³-A¹²-F¹¹ (VI)

wherein

A¹² to A¹⁴ each independently have the same meaning as A¹¹; B¹⁴ to B¹⁶ each independently have the same meaning as B¹²; B¹⁷ has the same meaning as B¹¹; E¹² has the same meaning as E¹¹; and

F¹² represents a hydrogen atom, an alkyl group having 1 to 13 carbon atoms, an alkoxy group having 1 to 13 carbon atoms, a cyano group, a nitro group, a trifluoromethyl group, a dimethylamino group, a hydroxyl group, a methylol group, a formyl group, a sulfo (—SO₃H) group, a carboxyl group, an alkoxycarbonyl group having 1 to 10 carbon atoms, or a halogen atom, provided that any —CH₂— that constitutes the alkyl group and alkoxy group is optionally replaced with —O—.

Specific examples of the liquid crystal compound include compounds described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); compounds described in JP-A-2010-31223, JP-A-2010-270108, JP-A-2011-6360, and JP-A-2011-207765, and the like.

Specific examples of the compound (X) include compounds represented by following formulae (I-1) to (I-4), formulae (II-1) to (II-4), formulae (III-1) to (II-26), formulae (IV-1) to (IV-26), formulae (V-1) and (V-2), and formulae (VI-1) to (VI-6). In the following formulae, k1 and k2 each independently represent an integer of 2 to 12. These compounds (X) are preferred since the compounds are easily synthesized or are easily available.

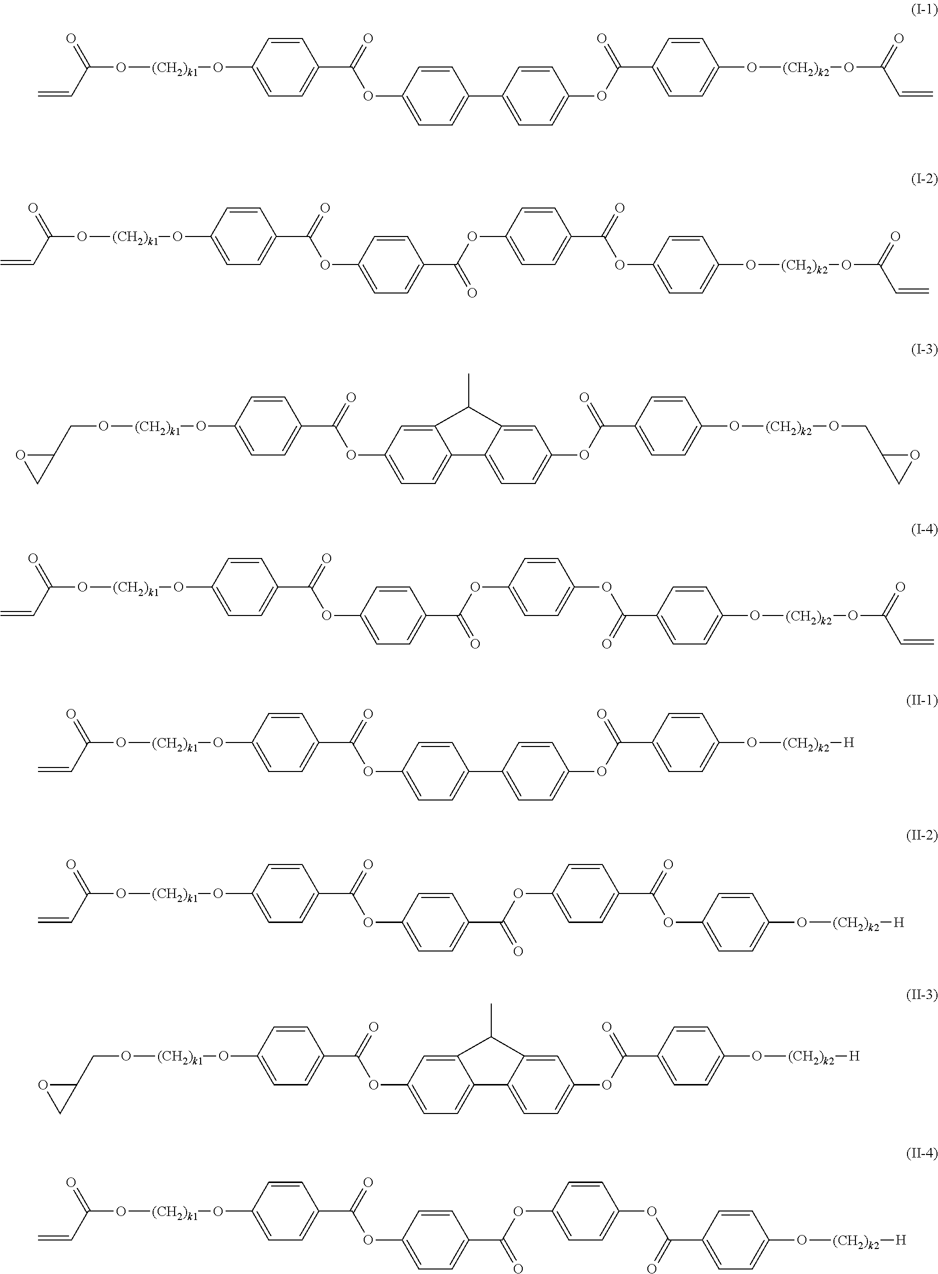

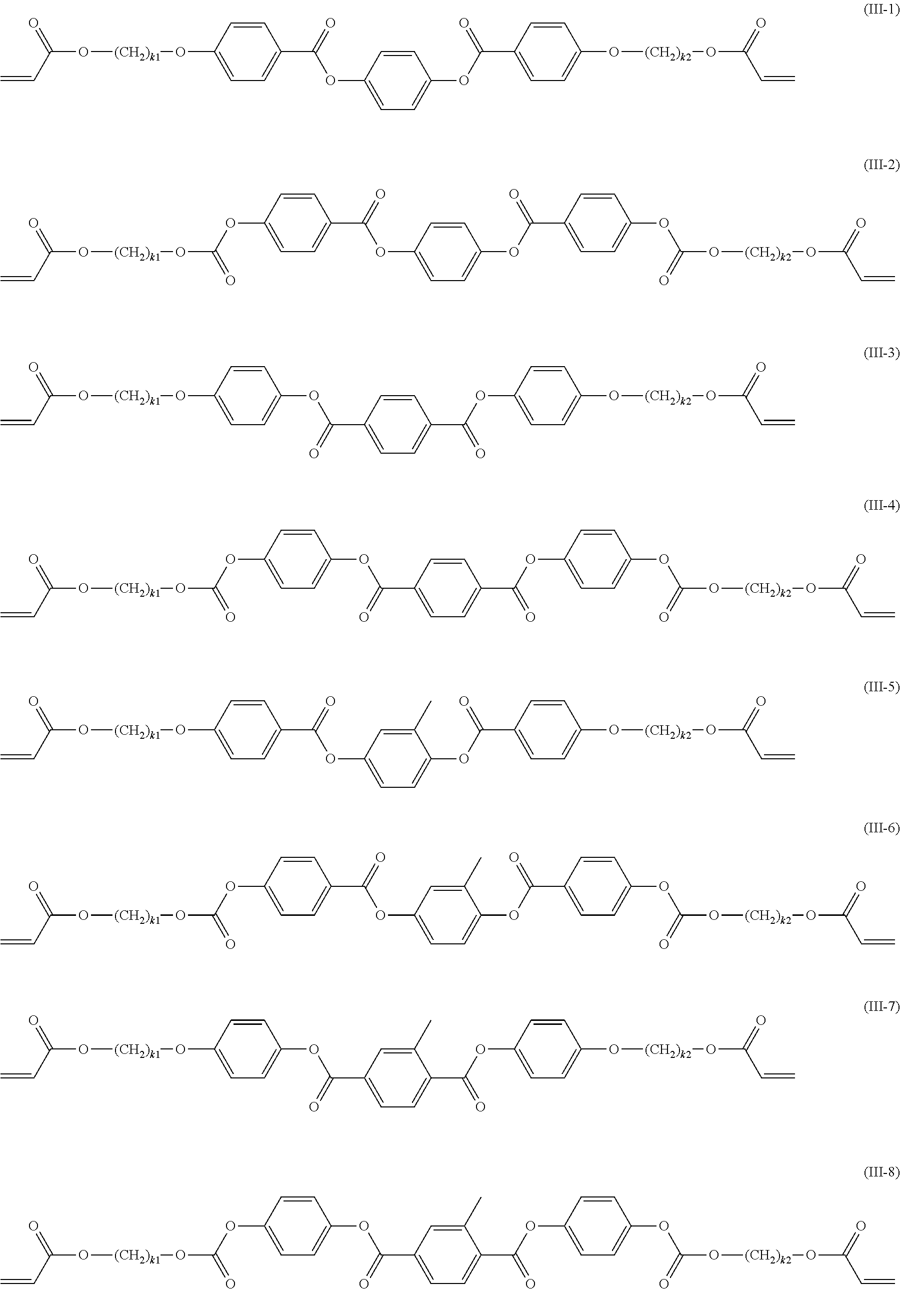

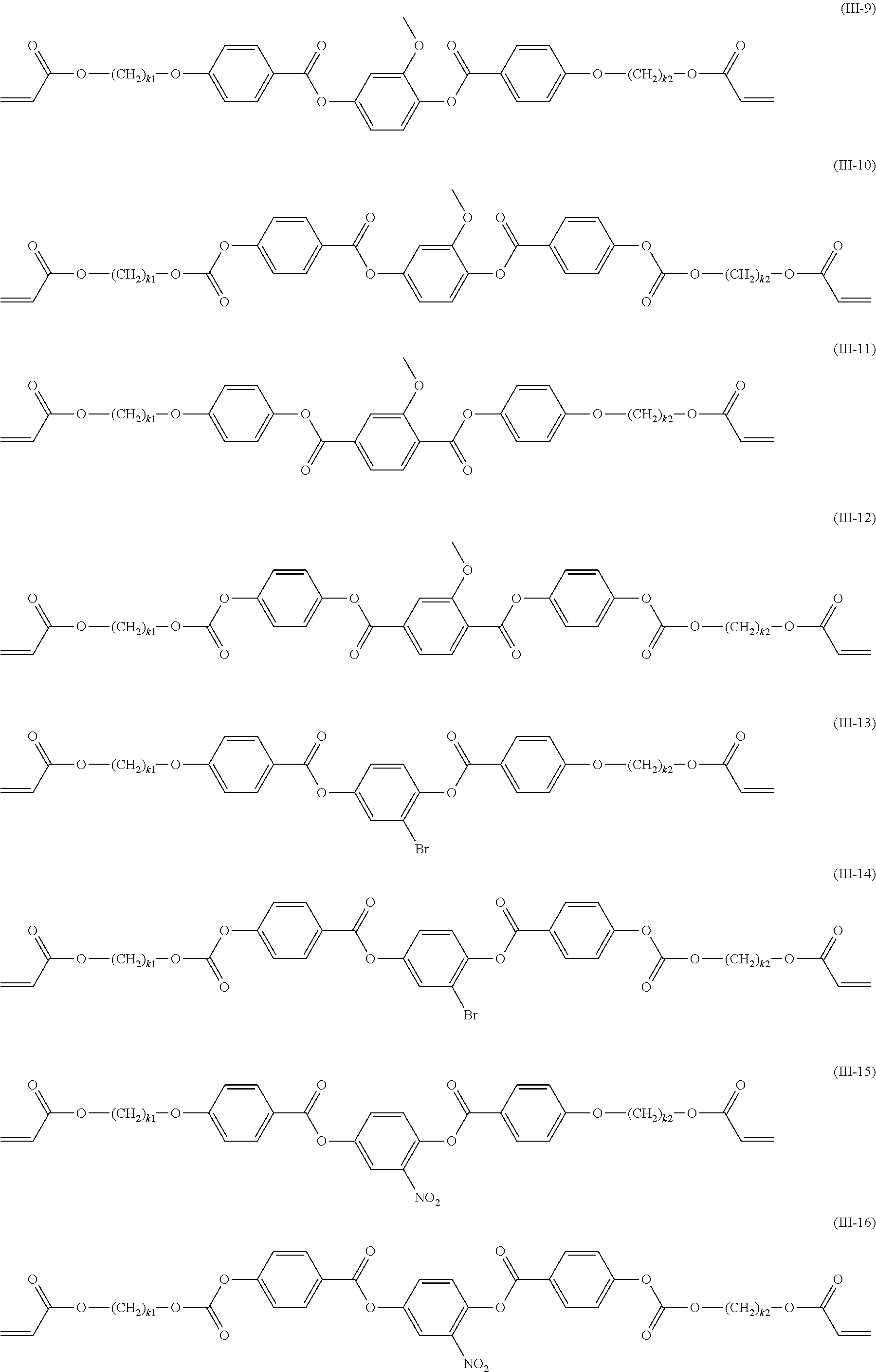

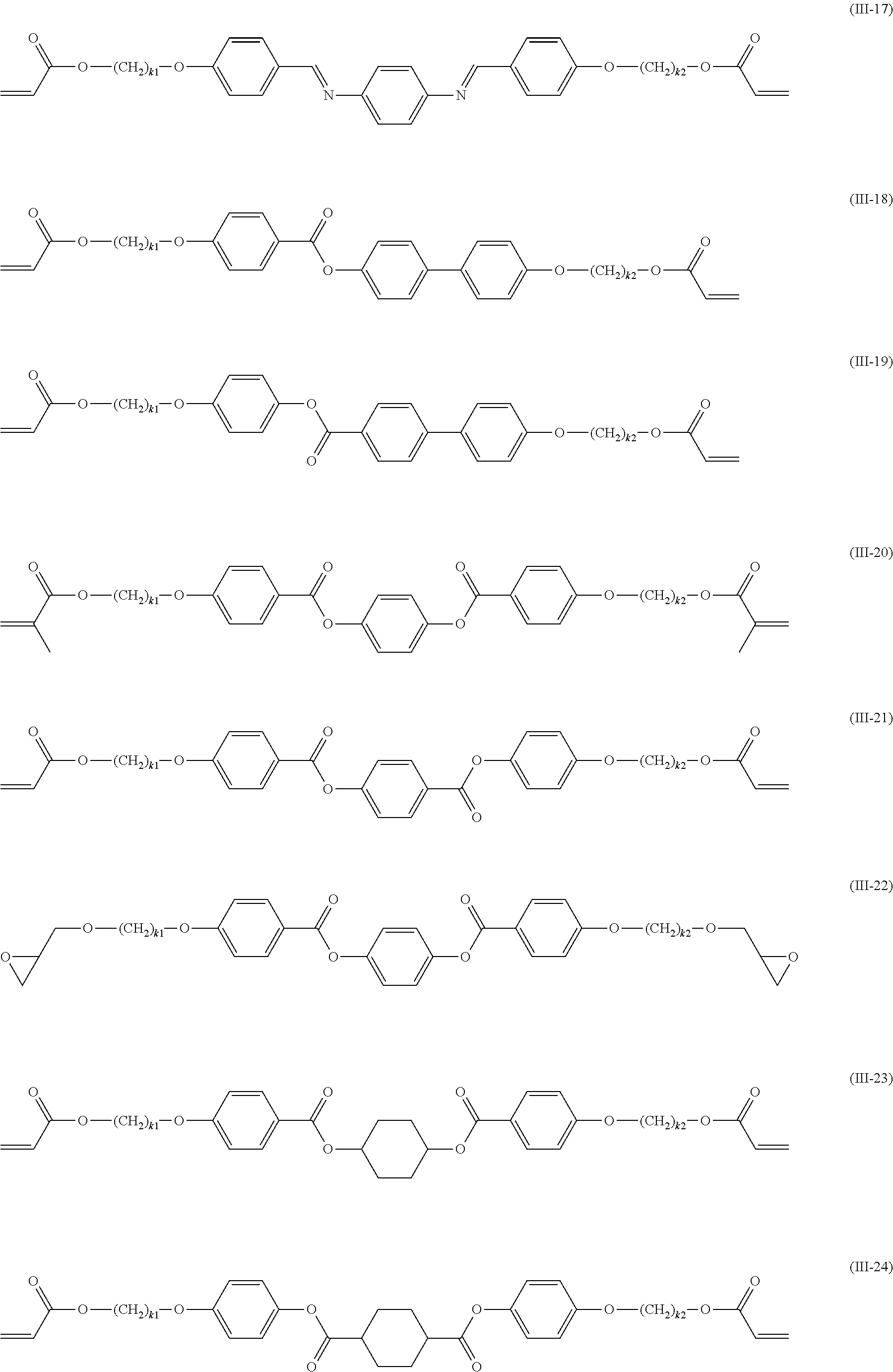

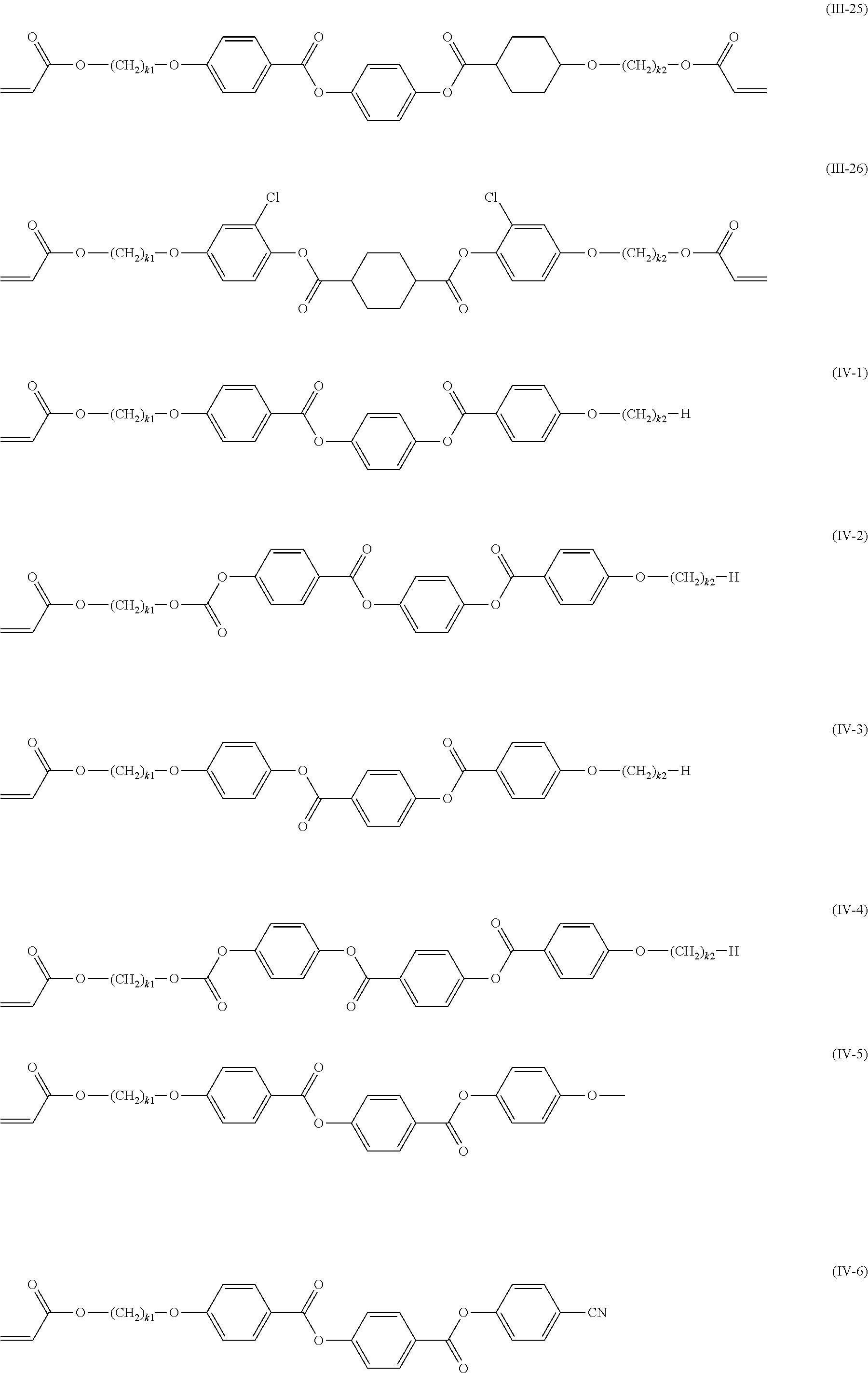

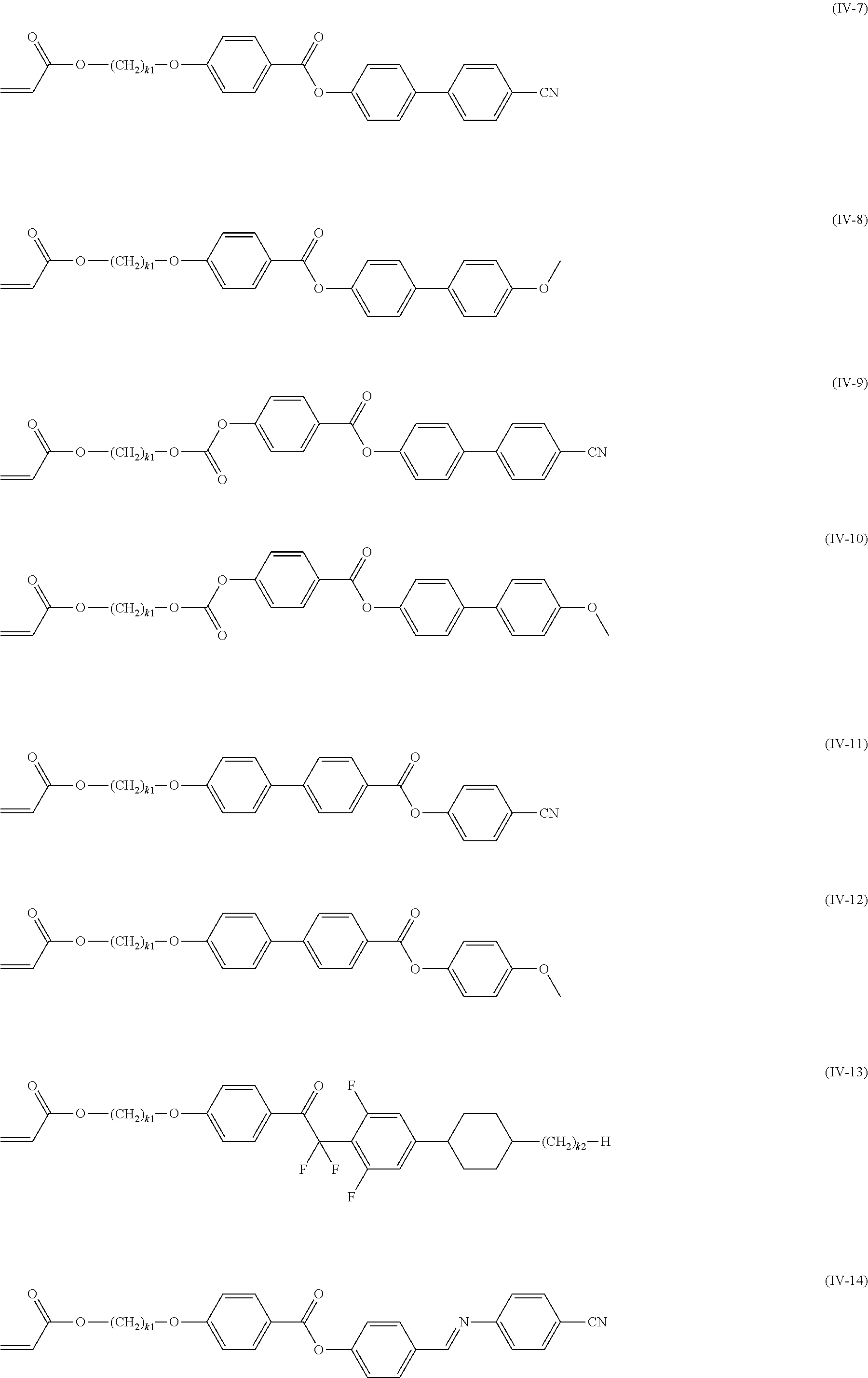

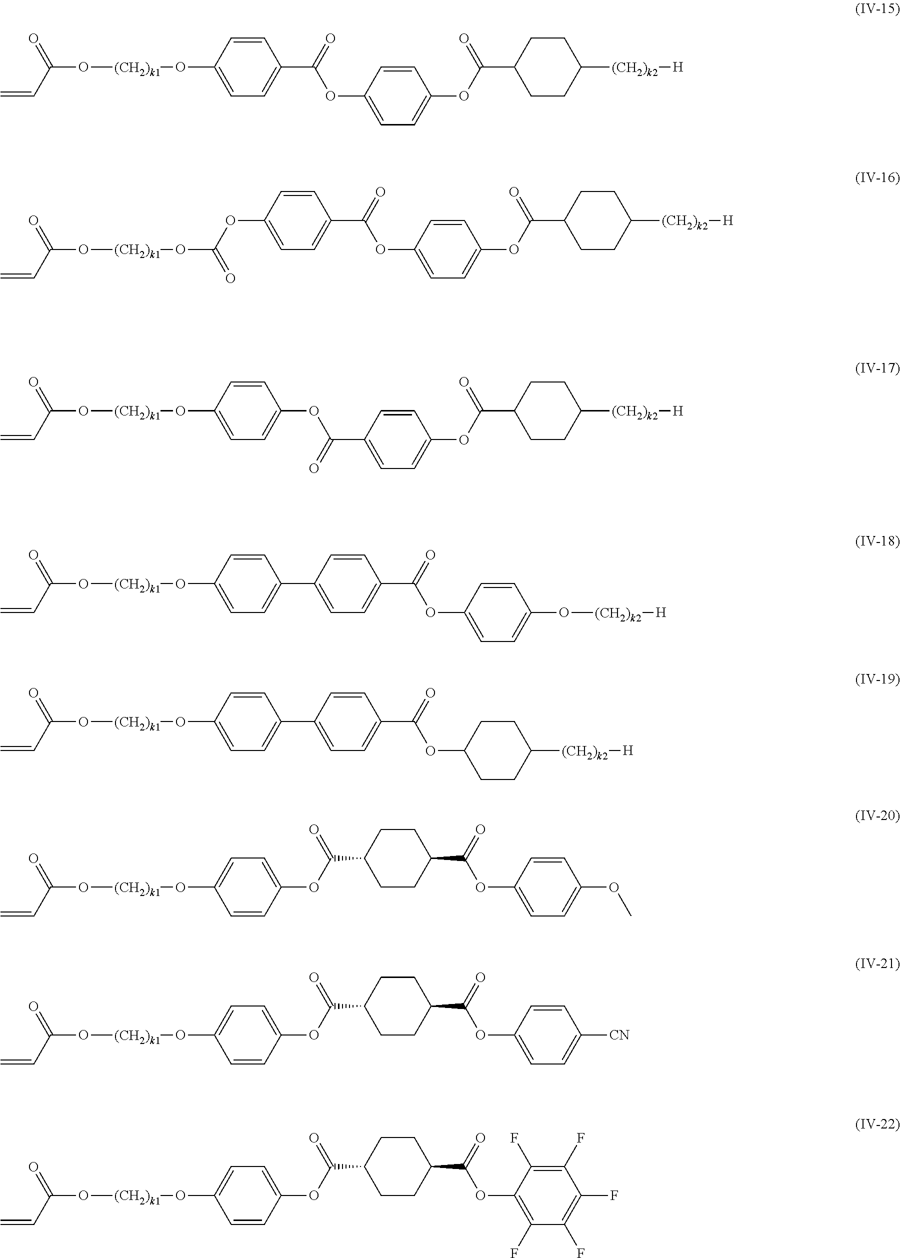

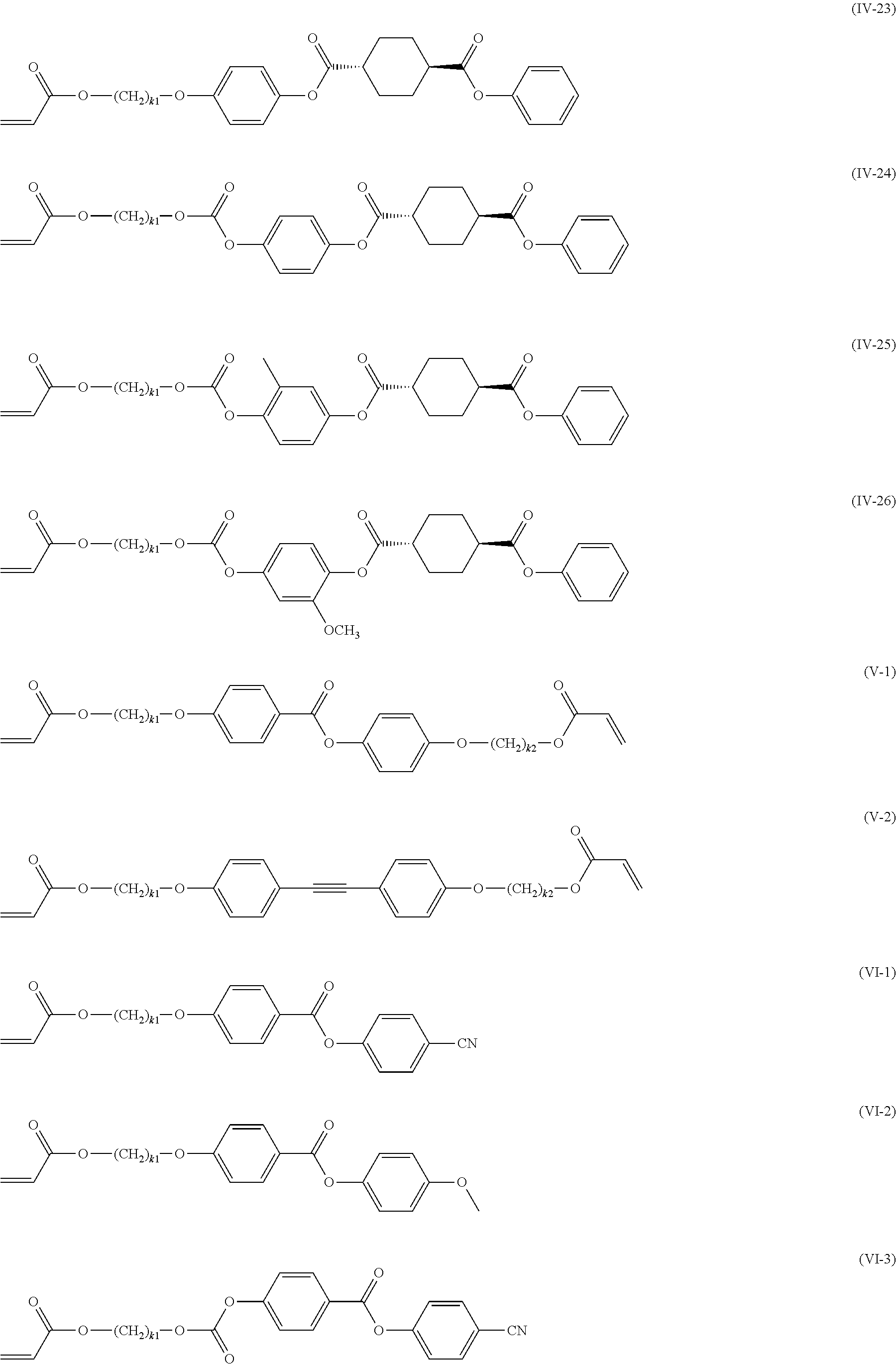

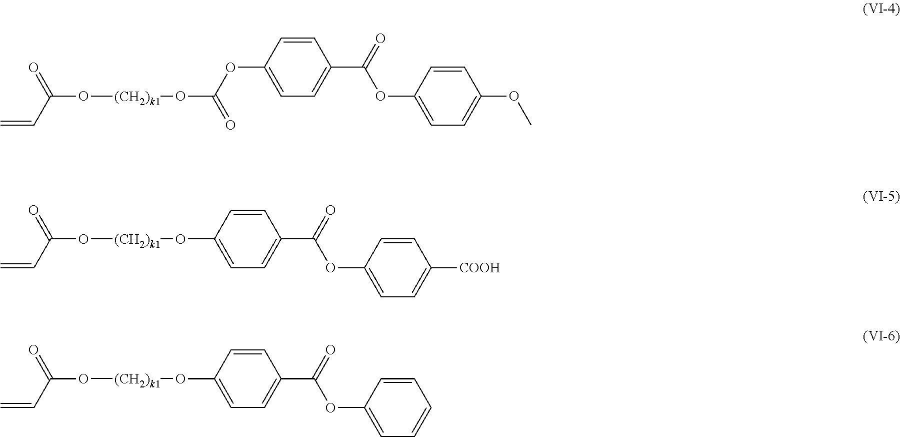

Besides the liquid crystal compound, the composition for forming an optically anisotropic layer may contain a polymerization initiator, a polymerization inhibitor, a photosensitizer, a leveling agent, a chiral agent, a reactive additive, a solvent, and the like. When the liquid crystal compound is a polymerizable liquid crystal compound, the composition for forming an optically anisotropic layer preferably contains a polymerization initiator.

### [Polymerization Initiator]

The polymerization initiator is preferably a photopolymerization initiator, more preferably a photopolymerization initiator which generates radicals by photoirradiation.

Examples of the photopolymerization initiator include benzoin compounds, benzophenone compounds, benzyl ketal compounds, α-hydroxyketone compounds, α-aminoketone compounds, α-acetophenone compounds, triazine compounds, iodonium salts and sulfonium salts. Specific examples thereof include IRGACURE 907, IRGACURE 184, IRGACURE 651, IRGACURE 819, IRGACURE 250, and IRGACURE 369 (all manufactured by Ciba Japan K.K.); SEIKUOL BZ, SEIKUOL Z, and SEIKUOL BEE (all manufactured by Seiko Chemical Co., Ltd.); KAYACURE BP100 (manufactured by Nippon Kayaku Co., Ltd.); KAYACURE UVI-6992 (manufactured by the Dow Chemical Company); ADEKA OPTOMER SP-152, and ADEKA OPTOMER SP-170 (all manufactured by Adeka Corporation); TAZ-A and TAZ-PP (all manufactured by Nihon Siber Hegner K.K.), and TAZ-104 (manufactured by Sanwa Chemical Co., Ltd.); and the like. Among them, preferred are α-acetophenone compounds. Examples of the α-acetophenone compounds include 2-methyl-2-morpholino-1-(4-methylsulfanylphenyl)propan-1-one, 2-dimethylamino-1-(4-morpholinophenyl)-2-benzylbutan-1-one, 2-dimethylamino-1-(4-morpholinophenyl)-2-(4-methylphenylmethyl)butane-1-one, and the like. More preferred are 2-methyl-2-morpholino-1-(4-methylsulfanylphenyl)propane-1-one, and 2-dimethylamino-1-(4-morpholinophenyl)-2-benzylbutan-1-one. Commercially available product examples of the α-acetophenone compounds include IRGACUREs 369, 379EG, and 907 (all manufactured by BASF Japan Ltd.), SEIKUOL BEE (manufactured by Seiko Chemical Co., Ltd.), and the like.

The polymerization initiator is usually from 0.1 parts by mass to 30 parts by mass, preferably from 0.5 parts by mass to 10 parts by mass, related to 100 parts by mass of the liquid crystal compound. The content in the above range is preferred since liquid crystal orientation of the liquid crystal compound is unlikely to be disturbed, and the polymerizable liquid crystal compound can be polymerized without disturbing the liquid crystal orientation of this compound.

### [Polymerization Inhibitor]

Examples of the polymerization inhibitor include hydroquinone and hydroquinone analogues each having a substituent such as an alkyl ether; butylcatechol, and other catechol compounds each having a substituent such as an alkyl ether; radical scavengers such as pyrogallol compounds, and 2,2,6,6-tetramethyl-1-piperidinyloxy radicals; thiophenol compounds; β-naphthylamine compounds; and β-naphthol compounds.

The content of the polymerization inhibitor in the composition for forming an optically anisotropic layer is usually from 0.1 parts by mass to 30 parts by mass, preferably from 0.5 parts by mass to 10 parts by mass, related to 100 parts by mass of the liquid crystal compound. The content in the above range is preferred since liquid crystal orientation of the liquid crystal compound is unlikely to be disturbed, and the polymerizable liquid crystal compound can be polymerized without disturbing the liquid crystal orientation of this compound.

### [Photosensitizer]

Examples of the photosensitizer include xanthone, and xanthone analogues such as thioxanthone; anthracene, and anthracene analogues having a substituent such as an alkyl ether; phenothiazine; and rubrene.

The use of the photosensitizer makes it possible to heighten the sensitivity of the photopolymerization initiator. The content of the photosensitizer is usually from 0.1 parts by mass to 30 parts by mass, preferably from 0.5 parts by mass to 10 parts by mass, related to 100 parts by mass of the liquid crystal compound.

### [Leveling Agent]

Examples of the leveling agent include organic modified silicone oil-based, polyacrylate-based, and perfluoroalkyl-based leveling agents. Specific examples thereof include DC3PA, SH7PA, DC11PA, SH28PA, SH29PA, SH30PA, ST80PA, ST86PA, SH8400, SH8700 and FZ2123 (all manufactured by Dow Corning Toray Co., Ltd.); KP321, KP323, KP324, KP326, KP340, KP341, X22-161A and KF6001 (all manufactured by Shin-Etsu Chemical Co., Ltd.); and TSF400, TSF401, TSF410, TSF4300, TSF4440, TSF4445, TSF-4446, TSF4452 and TSF4460 (all manufactured by Momentive Performance Materials Inc.), FLUORINERTs (registered trademark) FC-72, FC-40, FC-43 and FC-3283 (all manufactured by Sumitomo 3M Limited); MEGAFACs (registered trademark) R-08, R-30, R-90, F-410, F-411, F-443, F-445, F-470, F-477, F-479, F-482 and F-483 (all manufactured by DIC Corporation); EFTOPs (trade name) EF301, EF303, EF351 and EF352 (all the products are manufactured by Mitsubishi Materials Electronic Chemicals Co., Ltd.); SURFLONs (registered trademark)S-381, S-382, S-383, S-393, SC-101, SC-105, KH-40 and SA-100 (all manufactured by AGC Seimi Chemical Co., Ltd.); trade names of E1830 and E5844 (manufactured by Daikin Fine Chemical Laboratory Co., Ltd.); and trade names of BM-1000, BM-1100, BYK-352, BYK-353 and BYK-361N (all manufactured by BM Chemie GmbH). Such leveling agents may be used in any combination of two or more thereof.

The leveling agent makes it possible to yield a smoother optically anisotropic layer. Also, it is possible to control the fluidity of the composition for forming an optically anisotropic layer or adjust the crosslinkage density of the optically anisotropic layer in the production process of the optically anisotropic layer. The content of the leveling agent is usually from 0.1 parts by mass to 30 parts by mass, preferably from 0.1 parts by mass to 10 parts by mass, related to 100 parts by mass of the liquid crystal compound.

### [Chiral Agent]

Examples of the chiral agent include known chiral agents (for example, agents described in “Liquid Crystal Device Handbook”, Chapter 3, 4-3, Chiral Agents for TN and STN, p. 199, edited by Japan Society for the Promotion of Science, the 142nd Committee, 1989).

The chiral agent generally contains an asymmetric carbon atom, but an axially asymmetric compound or planarly asymmetric compound, which contains no asymmetric carbon atom, can be also used as the chiral agent. Examples of the axially asymmetric compound or planarly asymmetric compound include binaphthyl, helicene, paracyclophane, and derivatives of these compounds.

Specific examples thereof include compounds as described in JP-A-2007-269640, JP-A-2007-269639, JP-A-2007-176870, JP-A-2003-137887, JP-W-2000-515496, JP-A-2007-169178, and JP-W-09-506088. The chiral agent is preferably a product Paliocolor (registered trademark) LC756 manufactured by BASF Japan Ltd.

When the chiral agent is used, the content thereof is usually from 0.1 parts by mass to 30 parts by mass, preferably from 1.0 parts by mass to 25 parts by mass, related to 100 parts by mass of the liquid crystal compound. The content in the above range is preferred since liquid crystal orientation of the liquid crystal compound is unlikely to be disturbed, and the polymerizable liquid crystal compound can be polymerized without disturbing the liquid crystal orientation of this compound.

### [Reactive Additive]

The reactive additive preferably has a carbon-carbon unsaturated bond and an active hydrogen reactive group in the molecule thereof. The wording “active hydrogen reactive group” herein means a group reactive with a group having active hydrogen such as a carboxyl group (—COOH), hydroxyl group (—OH) or amino group (—NH₂). Typical examples thereof include glycidyl, oxazoline, carbodiimide, aziridine, imide, isocyanate, thioisocyanate, maleic anhydride groups, and the like.

It is preferred that the reactive additive has at least two active hydrogen reactive groups. In this case, the active hydrogen reactive groups may be the same as or different from each other.

The carbon-carbon unsaturated bond that the reactive additive has may be a carbon-carbon double bond, a carbon-carbon triple bond, or a combination of the two, and is preferably a carbon-carbon double bond. Among them, a reactive additive containing a carbon-carbon unsaturated bond as a vinyl group and/or a (meth)acrylic group is preferred as the reactive additive. Furthermore, the reactive additive is preferably a compound having, as its active hydrogen reactive group(s), at least one selected from the group consisting of epoxy, glycidyl and isocyanate groups; and is in particular preferably a reactive additive having an acrylic group and an isocyanate group.

Specific examples of the reactive additive include compounds each having a (meth)acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth)acrylic group and a lactone group, such as lactone acrylate and lactone methacrylate; compounds each having a vinyl group and an oxazoline group, such as vinyl oxazoline, and isopropenyl oxazoline; and oligomers of a compound having a (meth)acrylic group and an isocyanate group, such as isocyanatomethyl acrylate, isocyanatomethyl methacrylate, 2-isocyanatoethyl acrylate, and 20isocyanatoethyl methacrylate. Also, other examples thereof include compounds each having a vinyl group or vinylene group and an acid anhydride, such as methacrylic anhydride, acrylic anhydride, maleic anhydride, and vinylmaleic anhydride. Among them, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethyl acrylate, 2-isocyanatoethyl acrylate, and the above-mentioned oligomers.

Here, those having an isocyanate group as the active hydrogen reactive group that are more preferred as the reactive additive are specifically shown. For example, such a preferred reactive additive is represented by the following formula (Y):

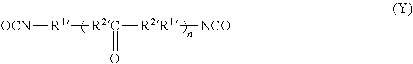

wherein

n represents an integer of 1 to 10, R^{1′}s each represent a bivalent aliphatic or alicyclic hydrocarbon group having 2 to 20 carbon atoms, or a bivalent aromatic hydrocarbon group having 5 to 20 carbon atoms; and one of two R^{2′}s in each of the recurring units is a group represented by —NH— and the other is a group represented by >N—C(═O)—R^{3′} wherein R^{3′} represents a hydroxyl group or a group having a carbon-carbon unsaturated bond.

At least one of R^{3′}s in the formula (Y) is a group having a carbon-carbon unsaturated bond.

Of the reactive additives represented by the formula (Y), particularly preferred is a compound represented by the following formula (YY) in which n has the same meaning as described above (hereinafter the compound may be referred to as the “compound (YY)”).

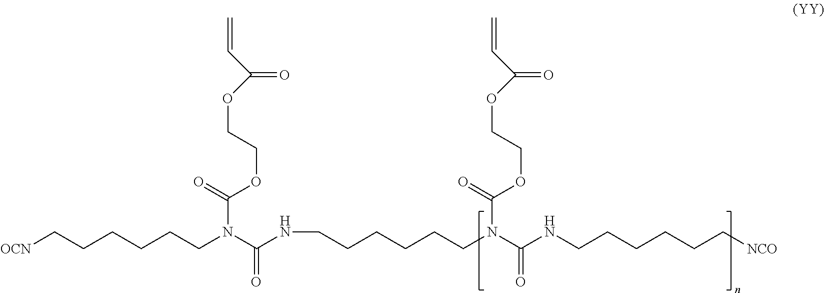

As the compound (YY), a commercially available product is usable as it is, or in the state of being purified if necessary. The commercially available product is a product Laromer (registered trademark) LR-9000 (manufactured by BASF).

The content of the reactive additive is usually from 0.1 parts by mass to 30 parts by mass, preferably from 0.1 parts by mass to 5 parts by mass, related to 100 parts by mass of the liquid crystal compound.

### [Solvent]

It is preferred that the composition for forming an optically anisotropic layer contains a solvent, particularly an organic solvent, in order to improve operability of production of the optically anisotropic layer. As the organic solvent, an organic solvent that can dissolve constituents of the composition for forming an optically anisotropic layer such as the liquid crystal compound is preferred, and when the composition for forming an optically anisotropic layer contains a polymerizable liquid crystal compound, a solvent that is inert to the polymerization reaction of the polymerizable liquid crystal compound is further preferred. Specific examples thereof include alcohol solvents such as methanol, ethanol, ethylene glycol, isopropyl alcohol, propylene glycol, methylcellosolve, butylcellosolve, propylene glycol monomethyl ether, and phenol; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; non-chlorinated aliphatic hydrocarbon solvents such as pentane, hexane, and heptane; non-chlorinated aromatic hydrocarbon solvents such as toluene and xylene; nitrile solvents such as acetonitrile; ether solvents such as tetrahydrofuran and dimethoxyethane; and chlorinated hydrocarbon solvents such as chloroform and chlorobenzene. Such organic solvents may be used in combination of two or more thereof. Among them, preferred are alcohol solvents, ester solvents, ketone solvents, non-chlorinated aliphatic hydrocarbon solvents, and non-chlorinated aromatic hydrocarbon solvents.

When the composition for forming an optically anisotropic layer contains an organic solvent, the content of the organic solvent is preferably 10 parts by mass to 10000 parts by mass, more preferably 100 parts by mass to 5000 parts by mass, related to 100 parts by mass of the solid content. The solid concentration in the composition for forming an optically anisotropic layer is preferably from 2% by mass to 50% by mass, more preferably from 5% to 50% by mass. The wording “solid content” means the entire components excluding the solvent from the composition for forming an optically anisotropic layer.

The optically anisotropic film is formed by coating a composition for forming an optically anisotropic layer onto the surface of the orientation film of the resin substrate with an orientation film, or coating and drying it. When the optically anisotropic film exhibits a liquid crystal phase such as a nematic phase, the film has a birefringence property related to mono-domain orientation.

The thickness of the optically anisotropic film can be adjusted depending on its use, and is preferably from 0.1 μm to 10 μm, and is further preferably from 0.2 μm to 5 μm to make the optically anisotropic film small in photoelasticity.

Examples of the method for the coating include extrusion coating, direct gravure coating, reverse gravure coating, CAP coating, slit coating, die coating methods, and the like. Also, examples include a method of coating using a coater such as a dip coater, a bar coater or a spin coater, and the like. Among them, preferred are CAP coating, inkjet coating, dip coating, slit coating, die coating, and bar-coater-used coating methods since these methods make it possible to attain the coating continuously in a roll-to-roll manner. When this composition is coated in a roll-to-roll manner, it is allowable to form an orientation film by coating the composition for forming an orientation film onto the resin substrate, and further form the optically anisotropic film continuously on the surface of the obtained orientation film.

Examples of the method for the drying include the same method as used for drying the composition for forming an orientation film when producing the resin substrate with an orientation film. Among them, preferred are natural drying and heat drying. The drying temperature is preferably in the range of 0° C. to 250° C., more preferably in the range of 50° C. to 220° C., and further preferably in the range of 80° C. to 170° C. The drying period is preferably from 10 seconds to 60 minutes, more preferably from 30 seconds to 30 minutes.

When the optically anisotropic film contains a polymerizable liquid crystal compound, the polymerizable liquid crystal compound can be also polymerized to be cured. In the optically anisotropic film formed by polymerization of a polymerizable liquid crystal compound, the liquid crystal orientation of the polymerizable liquid crystal compound is fixed so that the film is not easily affected by a birefringence change by heat.

The method for polymerizing the polymerizable liquid crystal compound is preferably photopolymerization. According to the photopolymerization, the compound can be polymerized at a low temperature; thus, choices for the resin substrate to be used can be increased in light of the heat resistance of the resin. The photopolymerization reaction is usually conducted by the irradiation of visible rays, ultraviolet rays, or a laser ray, and is preferably conducted by the irradiation of ultraviolet rays.

When the coated composition for forming an optically anisotropic layer contains the solvent, the photoirradiation is preferably performed after the solvent is dried to be removed. The drying may be performed simultaneously with the photoirradiation. It is however preferred to remove almost all of the solvent before the photoirradiation.

Thus, a laminated body having the resin substrate with an orientation film and an optically anisotropic film, in the order of the resin substrate, the orientation film and the optically anisotropic film, is obtained. The laminated body of the present invention is excellent in transparency in a visible light region, and is useful as a member for various display devices.

The laminated body in which the optically anisotropic film is a retardation film is particularly useful as a laminated body for converting a linearly polarized light when confirming from the oblique angle of a light emission side to a circularly polarizing light or an elliptically polarizing light, converting a circularly polarizing light or an elliptically polarizing light to a linearly polarized light, and converting the polarization direction of a linearly polarized light.

The laminated body in which the optically anisotropic film is a retardation film may be laminated in a plural number, and may be combined with other film. When combined with other film, the laminated body can be used as a viewing angle compensating film, a viewing angle enlarging film, an anti-reflection film, a polarizing plate, a circularly polarizing plate, an elliptically polarizing plate, or a brightness enhancement film.

The laminated body can be changed in optical property in accordance with the orientation state of the liquid crystal compound and is usable as a retardation plate for various liquid crystal display devices in a vertical alignment (VA) mode, an in-plane switching (IPS) mode, an optically compensated bend (OCB) mode, a twisted nematic (TN) mode, a super twisted nematic (STN) mode, and the like.

When the refractive index of the laminated body in the in-plane slow axis direction thereof is represented by n_{z}, that in the direction orthogonal to the in-plane slow axis (the fast axis direction) by n_{y}, and that in the thickness direction thereof by n_{z}, the laminated bodies can be classified as follows. The composition for forming an orientation film of the present invention is particularly preferably used in a positive C plate.

a positive A plate in which nₓ>n_{y}≈n_{z},
a negative C plate in which nₓ≈n_{y}>n_{z},
a positive C plate in which nₓ≈n_{y}<n_{z}, and
a positive O plate and a negative O plate in which nₓ≠n_{y}≠n_{z}

When the laminated body is used as a positive C plate, it is advisable to adjust the front retardation value Re(549) into the range of 0 to 10 nm, preferably into that of 0 to 5 nm, and adjust the retardation value Rₜₕ in thickness direction into the range of −10 to −300 nm, preferably into that of −20 to −200 nm. It is particularly preferred to adjust these values in accordance with properties of the liquid crystal cell.

The retardation value Rₜₕ in thickness direction, which means the refractive index anisotropy of the laminated body in the thickness direction, can be calculated from the retardation value R₅₀ measured in the state of inclining the in-plane fast axis at 50 degrees to be rendered an inclined axis, and the in-plane retardation value R₀. Specifically, the retardation value Rₜₕ in thickness direction can be calculated by obtaining nₓ, n_{y} and n_{z} through the following equations (9) to (11) from the in-plane retardation value R₀, the retardation value R₅₀, which is measured in the state of inclining the fast axis at 50 degrees to be rendered an inclined axis, the thickness d of the retardation film, and the average refractive index no of the retardation film; and then substituting these values for an equation (8).

Rₜₕ=[(nₓ+n_{y})/2−n_{z}]×d (8)

R₀=(nₓ−n_{y})×d (9)

R₅₀=(nₓ−n_{y}′)×d/cos(φ) (10)

(nₓ+n_{y}+n_{z})/3=n₀ (11)

wherein

φ=sin⁻¹[sin(50°)/n₀]

n_{y}′=n_{y}×n_{z}/[n_{y}²×sin²(φ)+n_{z}²×cos²(φ)]^{1/2}

In the laminated body of the present invention, the optically anisotropic film is formed on the surface of the orientation film having high adhesion to the resin substrate, thus peeling from the resin substrate is suppressed during processing. Adhesion can be evaluated by an adhesion test in accordance with JIS-K5600. For example, it is advisable to perform the adhesion test, using a commercially available device, such as a Cross-Cut Guide I Series device (CCI-1; a device for 25 squares having intervals of 1 mm) manufactured by COTEC CORPORATION. For example, when the adhesion test is made, using, for example, using a Cross-Cut Guide I Series device (CCI-1; a device for 25 squares having intervals of 1 mm) manufactured by COTEC CORPORATION, the number of squares in each of which the orientation film formed on the optically anisotropic film is held without being peeled from the resin substrate, out of the 25 squares, is usually 20 or more. Thus, 80% or more by area of the orientation film formed on the optically anisotropic film is held without being peeled from the resin substrate.

The laminated body of the present invention is also useful as a member which constitutes a polarizing plate.

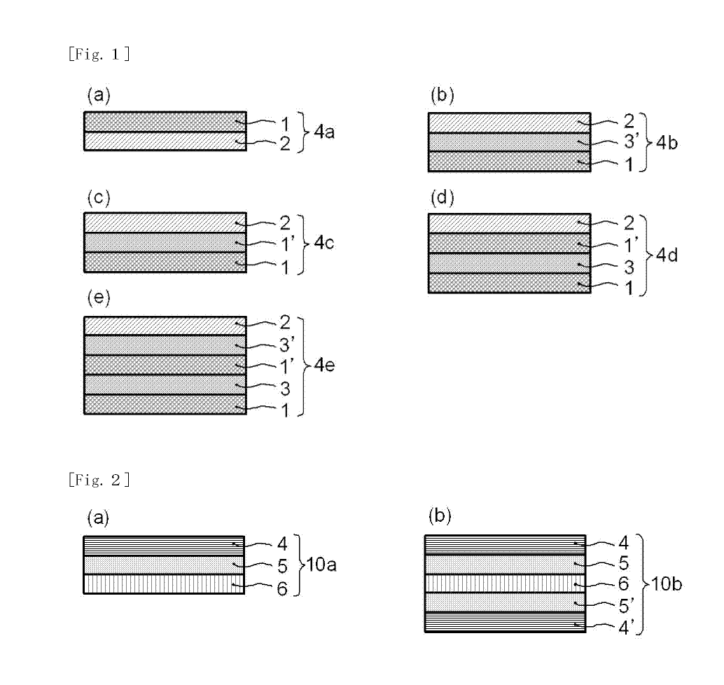

Specific examples of the polarizing plate include polarizing plates illustrated in FIGS. 1(a) to 1(e). The polarizing plate 4a illustrated in FIG. 1(a) is a polarizing plate in which a retardation film 1 and a polarization film 2 are laminated directly onto each other. The polarizing plate 4b illustrated in FIG. 1(b) is a polarizing plate in which a retardation film 1 and a polarization film 2 are bonded onto each other through an adhesive layer 3′. The polarizing plate 4c illustrated in FIG. 1(c) is a polarizing plate in which retardation films 1 and 1′ are laminated onto each other and further a polarization film 2 is laminated onto the retardation film 1′. The polarizing plate 4d illustrated in FIG. 1 (d) is a polarizing plate in which retardation films 1 and 1′ are bonded onto each other through an adhesive layer 3, and further a polarization film 2 is laminated onto the retardation film 1′. The polarizing plate 4e illustrated in FIG. 1(e) is a polarizing plate in which retardation films 1 and 1′ are bonded onto each other through an adhesive layer 3, and further the retardation film 1′ and a polarization film 2 are bonded onto each other through an adhesive layer 3′. The wording “adhesive” is a generic name of any adhesive and/or any pressure-sensitive adhesive.

The laminated body of the present invention in which the optically anisotropic film is a retardation film can be used for retardation films 1 and 1′, and the laminated body of the present invention in which the optically anisotropic film is a polarization film can be used for a polarization film 2. It is sufficient for the polarization film 2 to be a film having a polarizing function. Examples of the polarization film include a drawn film to which a dye having absorption anisotropy is adsorbed, a film to which a dye having absorption anisotropy is coated, and the like. Examples of the dye having absorption anisotropy include dichroic dyes such as iodine and azo compounds.

Examples of the drawn film to which a dye having absorption anisotropy is adsorbed include a film obtained by adsorbing a dichroic dye to a polyvinyl alcohol-based film, and then drawing the resultant; and a film obtained by drawing a polyvinyl alcohol-based film, and then adsorbing a dichroic dye to the resultant, and specific examples thereof include polarization films described in Japanese Patent No. 3708062 and Japanese Patent No. 4432487, and the like.

Examples of the film to which a dye having absorption anisotropy is coated include a film obtained by coating a composition containing a dichroic dye having liquid crystal property, or coating a composition containing a dichroic dye and a polymerizable liquid crystal compound, and specific examples thereof include polarization films described in JP-A-2012-33249, and the like.

The polarization film 2 may be protected by a protection film as necessary. Examples of the protection film include polyolefin films such as polyethylene, polypropylene and norbornene-based polymers, a polyethylene terephthalate film, a polymethacrylate film, a polyacrylate film, a cellulose ester film, a polyethylene naphthalate film, a polycarbonate film, a polysulfone film, a polyethersulfone film, a polyetherketone film, a polyphenylenesulfide film, and a polyphenylene oxide film.

The adhesive that forms the adhesive layers 3 and 3′ is preferably an adhesive high in transparency and excellent in heat resistance. Examples of the adhesive include acrylic-based, epoxy-based and urethane-based adhesives.

The display device of the present invention includes the laminated body of the present invention. Examples of the display device include a liquid crystal display device having a liquid crystal panel in which the laminated body of the present invention is stacked on a liquid crystal panel, and an organic electroluminescence (hereinafter also referred to as “EL”) display device having an organic EL panel in which the laminated body of the present invention and a luminous layer are stacked onto each other. The following will describe a liquid crystal display device as an embodiment of the display device provided with the laminated body of the present invention.

Examples of the liquid crystal display devices include liquid crystal display devices 10a and 10b illustrated in FIGS. 2(a) and 2(b), respectively. In the liquid crystal display device 10a illustrated in FIG. 2(a), the polarizing plate 4 of the present invention and a liquid crystal panel 6 are bonded through an adhesion layer 5. In the liquid crystal display device 10b illustrated in FIG. 2(b), the polarizing plate 4 of the present invention is bonded to one surface of a liquid crystal panel 6 through an adhesion layer 5 while a polarizing plate 1′ of the present invention is bonded to the other surface of the liquid crystal panel 6 through an adhesion layer 5′. Electrodes not illustrated are used in these liquid crystal display devices to apply a voltage to their liquid crystal panel to change the liquid crystal orientation of liquid crystal molecules. In this way, a monochrome display can be realized.

### EXAMPLES

Hereinafter, the present invention will be more specifically described by way of examples. In the examples, the symbol “%” dad the word “part(s)” denote “% by mass” and “part(s) by mass”, respectively, unless otherwise specified.

### [Preparation of a Composition for Forming an Orientation Film]

Compositions of composition for forming orientation films are shown in Table 1. Any of methylcyclohexane (boiling point of 100° C.), ethylcyclohexane (boiling point of 132° C.) or propylcyclohexane (boiling point of 157° C.) was added to a solution to which N-methyl-2-pyrrolidone and butylcellosolve were added to SUNEVER SE-610 (manufactured by Nissan Chemical Industries, Ltd.) (orienting polymer), to yield composition for forming orientation films (1) to (5).

TABLE 1

| | Solid | | | |
|---|---|---|---|---|
| | content of | N-methyl-2- | 2-Butoxyethanol | |
| | SE-610 | pyrrolidone | (Butylcellosolve) | Additive solvent |
| Composition for | 0.26 g | 36.8 g | 9.2 g | Methylcyclohexane |
| forming orientation | (0.5%) | (72.3%) | (18.1%) | 4.6 g (9.1%) |
| film (1) | | | | |
| Composition for | 0.26 g | 36.8 g | 9.2 g | Ethylcyclohexane |
| forming orientation | (0.5%) | (72.3%) | (18.1%) | 4.6 g (9.1%) |
| film (2) | | | | |
| Composition for | 0.26 g | 36.8 g | 9.2 g | Propylcyclohexane |
| forming orientation | (0.5%) | (72.3%) | (18.1%) | 4.6 g (9.1%) |
| film (3) | | | | |
| Composition for | 0.26 g | 36.8 g | 9.2 g | Ethylcyclohexane |
| forming orientation | (0.5%) | (66.3%) | (16.6%) | 9.2 g (16.6%) |
| film (4) | | | | |
| Composition for | 0.26 g | 36.8 g | 9.2 g | — |
| forming orientation | (0.5%) | (79.6%) | (19.9%) | |
| film (5) | | | | |

The value in parentheses in Table 1 represents the proportion of the content of each component in the total amount of the prepared composition. About the SE-610, the solid content was obtained by conversion from the concentration described in a delivery specification thereof.

### [Preparation of a Composition for Forming an Optically Anisotropic Layer]

The individual components shown in Table 2 were mixed, and the resultant solution was stirred at 80° C. for 1 hour, and then cooled to room temperature to yield composition for forming an optically anisotropic layer (1).

TABLE 2

| | Liquid | | | | |
|---|---|---|---|---|---|
| | crystal | Photopolymerization | Leveling | Reactive | |
| | compound | initiator | agent | additive | Solvent |
| Composition for | LC242 | Irg907 | BYK-361N | LR-9000 | PGMEA |
| forming | (19.2%) | (0.5%) | (0.1%) | (1.1%) | (79.1%) |
| optically | | | | | |
| anisotropic | | | | | |
| layer (1) | | | | | |

The value in parentheses in Table 2 represents the proportion of the content of each component in the total amount of the prepared composition.

In Table 2, LR-9000 represents LAROMER (registered trademark) LR-9000 manufactured by BASF Japan Ltd.; Irg907 represents IRGACURE 907 manufactured by BASF Japan Ltd.; BYK361N represents a leveling agent manufactured by BYK Japan K.K.; LC242 represents a liquid crystal compound manufactured by BASF represented by the following formula; and PGMEA represents propylene glycol-1-monomethyl ether-2-acetate.

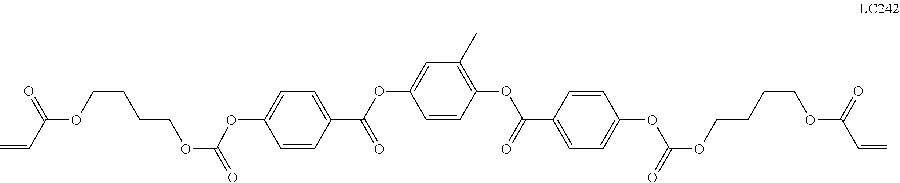 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

### Example 1

The surface of a cycloolefin polymer film (ZF-14, manufactured by Zeon Corporation) was once treated using a corona treating apparatus (AGF-B10, manufactured by Kasuga Electric Works Ltd.) at a power of 0.3 kW and a treating rate of 3 m/minute.

The composition for forming an orientation film (1) was coated onto the corona-treated surface and dried, to form a resin substrate with an orientation film having a thickness of 50 nm. The composition for forming an optically anisotropic layer (1) was coated onto the surface of the resin substrate with an orientation film using a bar coater. The resultant workpiece was heated to 100° C., dried and cooled to room temperature. Thereafter, Unicure (VB-15201BY-A, manufactured by USHIO INC.) was used to irradiate ultraviolet ray (wavelength of 365 nm, illuminance of 40 mW/cm²) onto the workpiece for 30 seconds to obtain laminated body (1) in which the resin substrate, the orientation film and the optically anisotropic film are laminated in this order.

### Example 2

A laminated body (2) was yielded in the same way as in Example 1 except that the composition for forming an orientation film (1) in Example 1 was changed to the composition for forming an orientation film (2).

### Example 3

A laminated body (3) was yielded in the same way as in Example 1 except that the composition for forming an orientation film (1) in Example 1 was changed to the composition for forming an orientation film (3).

### Example 4

A laminated body (4) was yielded in the same way as in Example 1 except that the composition for forming an orientation film (1) in Example 1 was changed to the composition for forming an orientation film (4).

### Comparative Example 1

A laminated body (5) was yielded in the same way as in Example 1 except that the composition for forming an orientation film (1) in Example 1 was changed to the composition for forming an orientation film (5).

### [Adhesion Evaluation]

The peeling resistance of the laminated bodies (1) to (4) yielded above was evaluated according to JIS-K5600, using a Cross-Cut Guide I Series device (CCI-1; a device for 25 squares having intervals of 1 mm) manufactured by COTEC CORPORATION. After the peeling test, the result of counting the remaining number of the orientation film held without being peeled from the resin substrate and the remaining ratio (non-peelable ratio by area) are shown in Table 3. Here, the laminated bodies were all held without being peeled from the orientation film and the optically anisotropic film.

### [Optical Property Measurement]

The retardation value of the laminated bodies (1) to (5) yielded above was measured using a measuring instrument (KOBRA-WR, manufactured by Oji Scientific Instruments). The measurement was made while the incident angle of light into the sample was varied, and it was checked whether or not its liquid crystal was vertically oriented. The retardation value R0(λ) is a retardation value at an incident angle of 0 (front), and R50(λ) is a retardation value at an incident angle of 50 (inclination around the fast axis), and each was measured at a wavelength (λ) of 549 nm. Also, the film thickness of the optically anisotropic film was measured using a laser microscope (LEXT3000, manufactured by Olympus Corporation). The results are shown in Table 3.

Using the resulting retardation values R0(549) and R50(549), the refractive indexes nₓ, n_{y} and n_{z} of the optically anisotropic film were calculated through the above equations (9) to (11). The average refractive index no was defined as 1.6. The results are shown in Table 4.

TABLE 3

| | | Remaining | Remaining | | | |
|---|---|---|---|---|---|---|
| | | number | ratio | | | Film |
| | | after | after | | | thick- |
| | | peeling | peeling | R0 | R50 | ness |
| | Orientation | test | test | (549) | (549) | (μm) |
| Example 1 | Vertical | 20/25 | 80% | 1.3 | 35.4 | 0.89 |
| | orientation | | | | | |
| Example 2 | Vertical | 25/25 | 100% | 1.4 | 38.4 | 0.96 |
| | orientation | | | | | |
| Example 3 | Vertical | 24/25 | 96% | 1.2 | 37.3 | 0.94 |
| | orientation | | | | | |
| Example 4 | Vertical | 25/25 | 100% | 1.2 | 36.2 | 0.92 |
| | orientation | | | | | |
| Comparative | Vertical | 0/25 | 0% | 1.3 | 36.4 | 0.92 |
| example 1 | orientation | | | | | |

TABLE 4

| | nx | ny | Nz |
|---|---|---|---|
| Example 1 | 1.55 | 1.55 | 1.71 |
| Example 2 | 1.55 | 1.55 | 1.70 |
| Example 3 | 1.55 | 1.54 | 1.71 |
| Example 4 | 1.55 | 1.55 | 1.71 |
| Comparative | 1.55 | 1.55 | 1.71 |
| example 1 | | | |

The laminated bodies (1) to (5) were each a positive C plate in which nₓ≈n_{y}<n_{z}.

It could be confirmed that the laminated bodies yielded in Examples tend to be excellent in adhesion.

### INDUSTRIAL APPLICABILITY

According to the composition for forming an orientation film of the present invention, adhesion between an orientation film and a resin substrate can be improved, and further, adhesion between a resin substrate, an orientation film and an optically anisotropic film can be improved in a laminated body having a resin substrate, an orientation film and an optically anisotropic film.

### DESCRIPTION OF REFERENCE SIGNS

1, 1′: Retardation film
2, 2′: Polarization film
3, 3′: Adhesive layer
4a, 4b, 4c, 4d, 4e, 4, 4′: Polarizing plate
5, 5′: Adhesion layer
6: Liquid crystal panel
10a, 10b: Liquid crystal display device

1. A composition for forming an orientation film comprising a material for forming an orientation film, N-methyl-2-pyrrolidone, and a hydrocarbon with a boiling point of 100° C. to 200° C.

2. The composition for forming an orientation film according to claim 1, wherein the hydrocarbon with a boiling point of 100° C. to 200° C. is at least one kind selected from the group consisting of methylcyclohexane, ethylcyclohexane and propylcyclohexane.

3. The composition for forming an orientation film according to claim 1, wherein the content of N-methyl-2-pyrrolidone is 60% by mass to 99.9% by mass, and the content of hydrocarbon with a boiling point of 100° C. to 200° C. is 0.1% by mass to 40% by mass, related to the total amount of the composition for forming an orientation film.

4. The composition for forming an orientation film according to claim 1, wherein the material for forming an orientation film contains at least one kind selected from polyimide, polyamide and polyamic acid.

5. A resin substrate with an orientation film having an orientation film formed from the composition for forming an orientation film according to claim 1, on the surface of the resin substrate.

6. The resin substrate with an orientation film according to claim 5, wherein the resin substrate is made of a polyolefin resin.

7. A method for producing a resin substrate with an orientation film comprising coating the composition for forming an orientation film according to claim 1 onto the resin substrate and drying the composition for forming an orientation film.

8. A laminated body having the resin substrate with an orientation film according to claim 5 and an optically anisotropic film, in the order of the resin substrate, the orientation film and the optically anisotropic film.

9. The laminated body according to claim 8, wherein 80% or more of the orientation film is not peeled off from the resin substrate, on an area basis, in an adhesion test in accordance with JIS-K5600.

10. The laminated body according to claim 8, wherein the optically anisotropic film is a retardation film.

11. The laminated body according to claim 8 for an IPS (in-plane switching) liquid crystal display device.

12. A method for producing a laminated body having a resin substrate, an orientation film and an optically anisotropic film, in this order, comprising coating the composition according to claim 1 onto the resin substrate to produce the resin substrate with an orientation film, coating a composition further containing a polymerizable liquid crystal compound and a photopolymerization initiator onto the surface of the orientation film of the resin substrate with an orientation film, and photoirradiating the composition.

13. A polarizing plate having the laminated body according to claim 8.

14. A display device comprising the laminated body according to claim 8.
